(19) United States
(12) Patent Application Publication
(10) Pub. No.: US 2025/0257200 A1
(43) Pub. Date: Aug. 14, 2025

(54) POLYMERIC COMPOSITIONS CONTAINING NANOCOMPOSITE FOR FORMING FILM

(71) Applicant: Westlake Longview Corporation, Houston, TX (US)

(72) Inventors: Darren Lavon SMITH, Kilgore, TX (US); Kranthi Chaitanya DANDA, Longview, TX (US)

(73) Assignee: Westlake Longview Corporation, Houston, TX (US)

(21) Appl. No.: 19/050,701

(22) Filed: Feb. 11, 2025

Related U.S. Application Data
(60) Provisional application No. 63/552,296, filed on Feb. 12, 2024.

(51) Int. Cl. C08L 23/06; B29C 48/00; B29C 48/08; B29C 48/375; B29K 23/00; B29K 29/00; B29K 77/00; B29K 105/00; B29K 105/26; C08J 5/18; C08K 3/34

(52) U.S. Cl. CPC C08L 23/06; B29C 48/022; B29C 48/08; B29C 48/375; C08J 5/18; C08K 3/346; B29K 2023/0625; B29K 2029/04; B29K 2077/00; B29K 2105/251; B29K 2105/26; B29K 2995/0018; B29K 2995/0089; C08J 2323/06; C08J 2329/04; C08J 2477/02; C08K 2201/011; C08L 2203/16; C08L 2205/03; C08L 2207/06; C08L 2207/20

(57) ABSTRACT

Disclosed is a polymeric composition useful for making films. The composition includes an ungrafted ethylene-based polymer, a nanocomposite containing a polyamide and montmorillonite, and optionally, an ethylene-vinyl alcohol (EVOH) copolymer. The composition is free of an added compatibilizer. Films made from the composition can have comparable or better optical and/or mechanical properties than films made from similar compositions containing compatibilizers.

### CROSS-REFERENCE TO RELATED APPLICATION/PRIORITY CLAIM

Priority of U.S. Provisional Patent Application No. 63/552,296 filed on Feb. 12, 2024, is hereby claimed; the entire content of which is hereby incorporated by reference.

### FIELD OF THE INVENTION

The invention generally relates to polymeric compositions useful for forming films, films containing the compositions, and processes for making the films.

### BACKGROUND OF THE INVENTION

Compatibilization of polar polymers, such as polyamide (PA) and/or ethylene-vinyl alcohol (EVOH) copolymer, with non-polar polymers, such as polyethylene (PE), is commonly carried out with maleic anhydride (MAH) grafted polymers. However, such multi-component compositions can produce films having less than desirable optical and/or mechanical properties.

There is a need in the art for compositions that can form films containing PA, PE, and optionally, EVOH copolymer, having as good or better optical and/or mechanical properties than the same films compatibilized with MAH-grafted polymers.

The present invention addresses this need as well as others, which will become apparent from the following description and the appended claims.

### SUMMARY OF THE INVENTION

The invention is as set forth in the appended claims.

Briefly, in one aspect, the present invention provides a composition comprising:
(a) an ungrafted ethylene-based polymer;
(b) a nanocomposite comprising a polyamide and montmorillonite; and
(c) optionally, an ethylene-vinyl alcohol (EVOH) copolymer,
wherein the composition is free of an added compatibilizer.

The composition is particularly useful for making films, including mono- and multilayer films. Thus, in a second aspect, the invention provides a film comprising at least one layer formed from the composition.

In a third aspect, the invention provides a method of making a film from the composition. The method includes the step of extruding a melt of the composition through a die.

### BRIEF DESCRIPTION OF THE DRAWINGS

FIGS. 1A-1C show optical microscopy images of the blown film formed from Example 2.

FIG. 1D is an enlarged view of area X from FIG. 1A.

FIGS. 2A-2C show optical microscopy images of the blown film formed from Example 3.

FIGS. 3A-3C show optical microscopy images of the blown film formed from Example 4.

FIGS. 4A-4C show optical microscopy images of the blown film formed from Example 5.

FIGS. 5A-5C show optical microscopy images of the blown film formed from Example 6.

FIGS. 6A-6C show optical microscopy images of the blown film formed from Example 9.

FIGS. 7A-7C show optical microscopy images of the blown film formed from Example 10.

FIGS. 8A-8C show optical microscopy images of the blown film formed from Example 11.

FIGS. 9A-9C show optical microscopy images of the cast film formed from Example 13.

FIGS. 10A-10C show optical microscopy images of the cast film formed from Example 14.

FIGS. 11A-11C show optical microscopy images of the cast film formed from Example 15.

### DETAILED DESCRIPTION OF THE INVENTION

It has been surprisingly discovered that compatibilizers, such as maleic anhydride (MAH) grafted polyethylenes, are not required to make films with suitable properties from a blend of polar and non-polar polymers. In particular, it is possible to make films from such polymers which have comparable or even better optical and/or mechanical properties than similar films containing a compatibilizer. The improved optical and/or mechanical properties include one or more of the following: higher gloss; lower haze; higher strength; higher elongation; higher toughness; higher dart impact; higher Elmendorf tear; higher puncture resistance; and fewer voids, gels, and immiscibility.

### Composition

Thus, in one aspect, the present invention provides a composition comprising:
(a) an ungrafted ethylene-based polymer;
(b) a nanocomposite comprising a polyamide and montmorillonite; and
(c) optionally, an ethylene-vinyl alcohol (EVOH) copolymer,
wherein the composition is free of an added compatibilizer.

The composition may contain from 1 to 99 wt %, from 10 to 99 wt %, from 20 to 99 wt %, from 30 to 99 wt %, from 40 to 99 wt %, from 50 to 99 wt %, from 55 to 99 wt %, from 60 to 99 wt %, from 65 to 99 wt %, from 70 to 99 wt %, from 75 to 99 wt %, from 80 to 99 wt %, from 85 to 99 wt %, from 90 to 99 wt %, from 93 to 99 wt %, from 95 to 99 wt %, or from 97 to 99 wt % of the ungrafted ethylene-based polymer, based on the weight of the composition.

The composition may contain from 0.1 to 40 wt %, from 0.1 to 35 wt %, 0.1 to 30 wt %, from 0.1 to 25 wt %, 0.1 to 20 wt %, from 0.1 to 15 wt %, from 0.1 to 10 wt %, from 1 to 7 wt %, or from 3 to 5 wt % of the nanocomposite, based on the weight of the composition.

In various embodiments, the composition includes an EVOH copolymer.

In various other embodiments, the composition excludes an EVOH copolymer.

If included, the composition may contain from 0.1 to 30 wt %, from 0.1 to 25 wt %, from 0.1 to 20 wt %, from 0.1 to 15 wt %, from 0.1 to 10 wt %, or from 0.1 to 5 wt % of the EVOH copolymer, based on the weight of the composition.

The composition may further comprise additional polar polymers, such as a non-composited polyamide.

In various embodiments, the composition further comprises a non-composited polyamide.

If included, the composition may contain from 0.1 to 40 wt %, from 0.1 to 35 wt %, 0.1 to 30 wt %, from 0.1 to 25 wt %, from 0.1 to 20 wt %, from 0.1 to 15 wt %, from 0.1 to 10 wt %, or from 0.1 to 5 wt % of the non-composited polyamide, based on the weight of the composition.

In various embodiments, the ungrafted ethylene-based polymer, the non-composited polyamide, the EVOH copolymer, or combinations thereof may be sourced from post-industrial or post-consumer waste.

Post-industrial waste refers to manufacturing scrap, while post-consumer waste refers to waste produced by the end-user.

The inventive composition may contain one or more conventional additives in typical amounts. Examples of the additives include heat stabilizers, antioxidants, lubricants, antistatic agents, dispersants, plasticizers, flame retardants, viscosity enhancers, ultraviolet light absorbers, light stabilizers, slip agents, anti-blocking agents, dyes, pigments, and fillers.

The composition may be a concentrate/masterbatch or a fully formulated/compounded formulation.

The terms “masterbatch” and “concentrate” are used interchangeably. They refer to a composition that has a higher concentration of any component (e.g., the nanocomposite or EVOH) than a fully compounded or a fully formulated composition. The masterbatch can include a carrier resin. One or more of the ungrafted ethylene-based polymers may be used as the carrier resin. The masterbatch is typically diluted with a letdown resin to form the fully formulated composition. One or more of the ungrafted ethylene-based polymers may be used as the letdown resin. The letdown resin may be the same or different polymer than the carrier resin. The masterbatch can be formed by dry mixing and/or melt blending the components. The fully formulated composition is what is used to form a shaped object, such as a film.

The composition may be prepared by melt blending the ingredients by any suitable method, such as by single-screw extrusion, co- or counter-rotating twin-screw extrusion, batch mixers, and any combination thereof. The ingredients may be introduced in the form of pellet, shred, grind, regrind, fluff, scrap, or any combination thereof.

Alternatively, the composition may be prepared by passing a film or films (containing one or more of the ingredients) through film shredding equipment, such as an Erema plastic recycling system. One or more ingredients of the composition may enter the recycling system in film form and may exit in pellet form, grind form, fluff form, or any combination thereof.

The film(s) introduced into the plastic recycling system may be virgin, post-consumer recycled (PCR), post-industrial recycled (PIR), or any combination thereof.

### Ethylene-Based Polymer

The terms “ethylene-based polymer” and “polyethylene” are used interchangeably herein. They refer to a polymer that contains more than 50 weight percent of polymerized ethylene monomer (based on the total amount of polymerizable monomers) and, optionally, may contain at least one comonomer. Ethylene-based polymer includes ethylene homopolymer and ethylene copolymers (meaning units derived from ethylene and one or more comonomers). Examples of ethylene-based polymer (polyethylene) include high-density polyethylene (HDPE), low-density polyethylene (LDPE), linear low-density polyethylene (LLDPE), very-low-density polyethylene (VLDPE), VLDPE with long branches, and ultra-low-density polyethylene (ULDPE) (also known as plastomers).

Generally, polyethylene may be produced in gas-phase, fluidized-bed reactors; liquid-phase, slurry process reactors; or liquid-phase, solution process reactors, using a heterogeneous catalyst system, such as Ziegler-Natta catalyst; a homogeneous catalyst system comprising Group 4 transition metals; and ligand structures, such as metallocene, non-metallocene metal-centered, heteroaryl, heterovalent aryloxyether, phosphine-imine, and others. Combinations of heterogeneous and/or homogeneous catalysts may also be used in either single-reactor or dual-reactor configurations.

In various embodiments, the ethylene-based polymer includes HDPE, LDPE, LLDPE, VLDPE, ULDPE, or combinations thereof.

In various embodiments, the ethylene-based polymer includes LLDPE.

In various embodiments, the ethylene-based polymer has a melt index (I₂) of 0.1 to 50 g/10 minutes, of 0.1 to 40 g/10 minutes, of 0.1 to 30 g/10 minutes, of 0.1 to 20 g/10 minutes, of 0.1 to 15 g/10 minutes, of 0.1 to 10 g/10 minutes, or of 0.1 to 5 g/10 minutes (measured according to ASTM D1238 at Condition 190/2.16).

### Polyamide

The terms “amide-based polymer” and “polyamide” are used interchangeably. They refer to a polymer that contains more than 50 percent of amide bonds between monomers and, optionally, may contain at least one other bond type. Amide-based polymers include homopolymers and copolymers (meaning more than one kind of monomer used to form the amide-based polymer). Examples of amide-based polymers (polyamides) include aliphatic and semi-aromatic. Examples of aliphatic polyamides include polycaprolactam, poly(hexamethylene adipamide), poly(hexamethylene succinimide), polylaurolactam, poly(11-aminoundecanoic acid), and poly(hexamethylene sebacimide). Examples of semi-aromatic polyamides include poly(hexamethylene terephthalamide), poly(hexamethylene isophthalamide), and polymers utilizing both terephthalic acid and isophthalic acid along with an aliphatic diamine.

The polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

Amorphous polyamide refers to a polyamide having insufficient crystallinity, that is, not having an endothermic crystalline melting peak when measured by differential scanning calorimetry (DSC) (ASTM D-3417, 10° C./min).

In general, the polyamide can be prepared using diamine and dicarboxylic acid. Examples of the diamine include hexamethylenediamine, 2-methylpentamethylenediamine, 2,2,4-trimethylhexamethylenediamine, 2,4,4-trimethylhexamethylenediamine, bis(4-aminocyclohexyl) methane, 2,2-bis(4-aminocyclohexyl) isopropylidene, 1,4-diaminocyclohexane, 1,3-diaminocyclohexane, meta-xylenediamine, 1,5-diaminopentane, 1,4-diaminobutane, 1,3-diaminopropane, 2-ethyldiaminobutane, 1,4-diaminomethylcyclohexane, methane-xylenediamine, alkyl-substituted or unsubstituted m-phenylenediamine and p-phenylenediamine, etc. Examples of the dicarboxylic acid include alkyl-substituted or unsubstituted isophthalic acid, terephthalic acid, adipic acid, sebacic acid, butanedicarboxylic acid, etc.

Polyamide prepared using an aliphatic diamine and an aliphatic dicarboxylic acid is generally semicrystalline polyamide. The semicrystalline polyamide is generally prepared using lactam, such as nylon 6 or nylon 11, or an amino acid, but may also be prepared by condensing a diamine, such as hexamethylenediamine, with a dibasic acid, such as succinic acid, adipic acid, or sebacic acid. The polyamide may be a copolymer or a terpolymer such as a copolymer of hexamethylenediamine/adipic acid and caprolactam (nylon 6,66). A mixture of two or more semicrystalline polyamides can also be used.

Amorphous polyamide is typically obtained when either diamine or dicarboxylic acid is aromatic, and the other is aliphatic. Examples of aliphatic groups of the amorphous polyamide include C₁-C₁₅ aliphatic or C₄-C₈ alicyclic alkyls. Examples of aromatic groups of the amorphous polyamide include substituted C₁-C₆ mono- or bicyclic aromatic groups.

Examples of amorphous polyamides include hexamethylenediamine isophthalamide, a mixture of 2,2,4- and 2,4,4-trimethylhexamethylenediamine terephthalamide, a copolymer of hexamethylenediamine or 2-methylpentamethylenediamine and an isophthalic acid, terephthalic acid, or mixtures thereof.

The semicrystalline and amorphous polyamides may be prepared by condensation polymerization, as well-known in the art.

In various embodiments, the polyamide includes nylon 4.6, nylon 6, nylon 6.6, nylon 6.10, nylon 6.12, nylon 11, nylon 12, amorphous nylon, or combinations thereof. In various embodiments, the polyamide includes nylon 6.

### Montmorillonite

The other component of the nanocomposite is montmorillonite.

Montmorillonite is a very soft phyllosilicate group of minerals that form when they precipitate from water solution as microscopic crystals, known as clay. Montmorillonite is a 2:1 clay, meaning that it has two tetrahedral sheets of silica sandwiching a central octahedral sheet of alumina. The particles are plate-shaped with average dimension of 1 nm thick and 70-150 nm wide. Chemically, it is hydrated sodium calcium aluminium magnesium silicate hydroxide (Na,Ca)_{0.33}(Al,Mg)₂(Si₄O₁₀)(OH)₂·nH₂O. Potassium, iron, and other cations are common substitutes, and the exact ratio of cations varies with the source.

The clay may or may not be modified with organic compounds having polar or ionic pendants, such as quaternary ammonium, phosphonium, maleate, succinate, acrylate, benzylic hydrogen, and oxazoline. If used, the content of the organic material may range from 1 to 45 wt %, based on the weight of the clay.

The clay layers can have a thickness of 1 to 100 nm and a length of 20 to 1000 nm. The clay's unit cell charge may vary from 0.3 to 0.8. The surface area of this material may vary from 400 to 1000 m²/g.

### Nanocomposite

The clay may be incorporated into the polyamide to form the nanocomposite using any suitable method, such as solid-melt blending, suspension-liquid feeding, solution-liquid feeding, or may be added during synthesis of the polyamide. The preferred method of incorporation is addition during synthesis of the polyamide.

The nanocomposite may contain from 1 to 20 wt %, or from 2 to 8 wt % of montmorillonite, based on the weight of the nanocomposite.

The nanocomposite may contain from 80 to 99 wt %, or from 92 to 98 wt % of polyamide, based on the weight of the nanocomposite.

### EVOH

The composition optionally further comprises an ethylene-vinyl alcohol (EVOH) copolymer.

The EVOH copolymer may have an ethylene content ranging from 25 to 50 mol %, or from 27 to 44 mol % of ethylene, based on the total moles of the EVOH copolymer.

### Compatibilizer

A compatibilizer is typically used to improve the compatibility of a non-polar polymer, such as a polyolefin, with a polar polymer, such as polyamide and ethylene-vinyl alcohol (EVOH) copolymer.

Typical compatibilizers include functionalized ethylene-based polymers, such as functionalized HDPE, functionalized LDPE, functionalized LLDPE, functionalized VLDPE, functionalized ULDPE, and combinations thereof.

Typical functional groups include carboxylic acids (saturated or unsaturated), esters, and/or anhydrides thereof.

The functionalized ethylene-based polymer may contain from 0.1 to 3.0 wt %, from 0.5 to 2.5 wt %, from 0.5 to 2.0 wt %, or from 1.0 to 2.0 wt % of the functional group, based on the weight of the functionalized ethylene-based polymer.

The compatibilizer may have a melt index of 0.5 to 1,500 g/10 min, of 0.5 to 1,000 g/10 min, of 30 to 1,000 g/10 min, or of 30 to 500 g/10 min (measured according to ASTM D1238 at Condition 190/2.16).

Examples of compatibilizers include an epoxy-modified polystyrene copolymer, an ethylene-(meth)acrylate copolymer, an ethylene-alkyl (meth)acrylate copolymer (e.g., ethylene-methyl acrylate copolymer (block or random) and ethylene-butyl acrylate copolymer (block or random)), an ethylene-vinyl acetate copolymer, and combinations thereof.

Additional examples of compatibilizers include anhydride and/or carboxylic acid functionalized ethylene-based polymers, such as a maleic anhydride grafted polyethylene, a maleic anhydride grafted ethylene-(meth)acrylate copolymer, a maleic anhydride grafted ethylene-alkyl (meth)acrylate copolymer (e.g., maleic anhydride grafted ethylene-methyl acrylate copolymer (block or random) and maleic anhydride grafted ethylene-butyl acrylate copolymer (block or random)), a maleic anhydride grafted ethylene-vinyl acetate copolymer, and combinations thereof.

Compatibilizers are not required in the compositions of the invention.

In various embodiments, the compositions of the invention exclude or are free of an added compatibilizer.

### Films

The compositions of the invention are particularly suitable for making films, particularly flexible films for packaging.

Thus, in a second aspect, the invention provides a film comprising the compositions described herein.

In various embodiments, the film is a flexible film.

The film may be single-layer or multilayer.

In various embodiments, the film is a single-layer blown film.

In various other embodiments, the film is a multilayer blown film.

The film may have a thickness in the range of 5 to 250 μm, or 5 to 125 μm.

### Method of Making Film

The films according to the invention may be made by any known method, including blown-film extrusion and cast-film extrusion. Both involve extrusion prior to film forming.

Thus, in a third aspect, the invention provides a method of making a film. The method includes the step of extruding a melt of the compositions of the invention through a die. The die includes a narrow slit, which may be either a straight-line or circular. The resulting thin film has the form of either a sheet (cast film) or a tube (blown film). As the film exits the die, it is cooled and then rolled up on a core.

In the extrusion step, resin pellets (or other suitable forms of the ingredients) are typically gravity fed into a heated barrel of an extruder. The pellets are conveyed down the barrel by a screw that first compacts and then melts the pellets through shear-induced heat. The last section of the screw, also known as the metering section, ensures a homogeneous melt and uniform output.

In the case of blown films, the polymer melt is forced through a tubular-shaped (or annular) die. After exiting the die, the molten tube of polymer is injected with air and generally pulled upward by a set of nip rolls, although in some cases, it can be pulled horizontally or downward. As film thickness is reduced, the tube expands because of internal bubble pressure and forms a tube of larger diameter. Air rings aid in film cooling by supplying air flow around the molten tube. The tube is then drawn down to a desired final film thickness, for example, in the range of 5 to 250 μm, or from 10 to 125 μm.

In the case of cast films, the polymer melt is extruded through a flat sheet extrusion die (often referred to as a “flat die”). The flat die may have various designs, such as “keyhole,” “T-shaped,” or “coat hanger.” The molten sheet of polymer (cast film) is usually extruded downward, but in some cases, can be extruded horizontally. Within inches after exiting the die, the sheet is deposited onto a rotating chilled roller where the melt is cooled and solidified. An air knife can be used in conjunction with the chill roller to expedite cooling. The chill roller can be polished smooth, have a matte finish, or be embossed with a repeating pattern. Following quenching, the film can go over a nip roll before being wound at a winding station. Film edges are usually trimmed, chopped, and re-introduced into the system as flaky material called “fluff” or “regrind.” The film thickness can be reduced at the nip roll. Thickness can also be controlled by altering the winder speed and the nip tension. The film can be subjected to lateral draw with the use of drawing pins to a desired final film thickness. Film thicknesses can range, for example, in the range of 5 to 250 μm, or from 10 to 125 μm.

### General Provisions

To remove any doubt, the present invention includes and expressly contemplates and discloses any and all combinations of embodiments, features, characteristics, parameters, and/or ranges mentioned herein. That is, the subject matter of the present invention may be defined by any combination of embodiments, features, characteristics, parameters, and/or ranges mentioned herein.

It is contemplated that any ingredient, component, or step that is not specifically named or identified as part of the present invention may be explicitly excluded.

Any process/method, apparatus, compound, composition, embodiment, or component of the present invention may be modified by the transitional terms “comprising,” “consisting essentially of,” or “consisting of,” or variations of those terms.

As used herein, the indefinite articles “a” and “an” mean one or more, unless the context clearly suggests otherwise. Similarly, the singular form of nouns includes their plural form, and vice versa, unless the context clearly suggests otherwise.

While attempts have been made to be precise, the numerical values and ranges described herein may be considered approximations. These values and ranges may vary from their stated numbers depending upon the desired properties sought to be obtained by the present disclosure as well as the variations resulting from the standard deviation found in the measuring techniques. Moreover, the ranges described herein are intended and specifically contemplated to include all sub-ranges and values within the stated ranges. For example, a range of 50 to 100 is intended to include all values within the range including sub-ranges such as 60 to 90, 70 to 80, etc.

Any two numbers of the same property or parameter reported in the working examples may define a range. Those numbers may be rounded off to the nearest thousandth, hundredth, tenth, whole number, ten, hundred, or thousand to define the range.

The content of all documents cited herein, including patents as well as non-patent literature, is hereby incorporated by reference in their entirety. To the extent that any incorporated subject matter contradicts with any disclosure herein, the disclosure herein shall take precedence over the incorporated content.

This invention can be further illustrated by the following working examples, although these examples are included merely for purposes of illustration and are not intended to limit the scope of the invention.

### EXAMPLES

### Analytical Methods

Gloss at 45° was measured according to ASTM D-2457.

Haze was measured according to ASTM D-1003.

Tensile strength, tensile toughness, elongation, and secant modulus were measured according to ASTM D-882.

Puncture resistance was measured according to ASTM D-5748.

Dart impact strength was measured according to ASTM D-1709 method A.

Elmendorf tear was measured according to ASTM D-1922.

### Example 1—Control

### Preparation of Polyethylene (PE) Film

100% (wt./wt.) of a linear low-density polyethylene (Westlake Chemical HIFOR® LF2020AA having a melt index of 1.0 g/10 min. and density of 0.919 g/cm³) was added to the feed of a monolayer film blowing line. The extrusion barrel temperature set point was 325° F. in zone 1, 450° F. in zone 2, 450° F. in zone 3, 420° F. in zone 4, 420° F. in zone 5, and 450° F. in all die zones. The screw speed was between 62 and 96 rpm, the melt pressure was between 1,848 and 2,399 psi, the nip pressure was 45 psi, the air temperature was 58° F., the film speed was 110 fpm (feet per minute), the bubble height was 15′ (feet), the bubble width was 22.5″ (inches), and the film thickness was 1.4 to 1.6 mils. The die gap was 100 mil, and the blow-up ratio was 2.5:1. The output of the process was 170 lbs/hr.

This film was then subjected to testing for packing film properties. The results are reported in Table 1 below.

### Example 2—Comparative

### Preparation of PE Film Containing Nanocomposite and Compatibilizer (RETAIN®)

55% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 nanocomposite (Domo Chemical 1300 IF 102.3), 10% (wt./wt.) of an ethylene-vinyl alcohol copolymer (Kuraray EVAL F104B), and 5% (wt./wt.) of a maleated polyethylene copolymer compatibilizer (Dow RETAIN® 3000 having a melt index of 660 g/10 min. and density of 0.870 g/cm³ and containing 1.4 wt % of grafted maleic anhydride) were added in pellet form to a twin-screw extruder and melt blended to form a concentrate. The extrusion barrel temperature set point was 150° C. in zone 1, 200° C. in zone 2, 205° C. in zone 3, 245° C. in zone 4, 250° C. in zone 5 through zone 10, 240° C. in zone 11, 215° C. in zone 12, and 215° C. at the die. The screw speed was 275 RPM (revolutions per minute) with a 25 SCFH (Standard Cubic Foot per Hour) nitrogen purge rate and a total output of 12.5 pounds per hour. The melt blend concentrate was pelletized for further processing.

35% (wt./wt.) of the resulting concentrate pellets and 65% (wt./wt.) of the linear low-density polyethylene resin (HIFOR® LF2020AA) were added to the feed of a monolayer film blowing line as a pellet blend to form a blown film. The film blowing line was operated at the same conditions as Example 1.

This film was then subjected to testing for packing film properties. The results are reported in Table 1 below.

### Example 3—Comparative

### Preparation of PE Film Containing Nylon and Compatibilizer (RETAIN®)

Pellets of a concentrate containing 55% (wt./wt.) of a linear low-density polyethylene (HIFOR® LF2020AA), 30% (wt./wt.) of a polyamide 6 without nanoparticles (Domo Chemical Domamide H40 F), 10% (wt./wt.) of an ethylene-vinyl alcohol copolymer (Kuraray EVAL F104B), and 5% (wt./wt.) of a maleated polyethylene copolymer compatibilizer (Dow RETAIN® 3000) were prepared using the procedure and conditions of Example 2.

35% (wt./wt.) of the resulting concentrate pellets and 65% (wt./wt.) of the linear low-density polyethylene resin (HIFOR® LF2020AA) were pellet blended and formed into a monolayer blown film using the procedure and conditions of Example 1.

This film was then subjected to testing for packing film properties. The results are reported in Table 1 below.

### Example 4—Comparative

### Preparation of PE Film Containing Nanocomposite and Compatibilizer (Mal-EMAC®)

Pellets of a concentrate containing 55% (wt./wt.) of a linear low-density polyethylene (HIFOR® LF2020AA), 30% (wt./wt.) of a polyamide 6 nanocomposite (Domo Chemical 1300 IF 102.3), 10% (wt./wt.) of an ethylene-vinyl alcohol copolymer (Kuraray EVAL F104B), and 5% (wt./wt.) of a maleated ethylene-methyl acrylate copolymer compatibilizer (melt index of 600 g/10 min., 24 wt % methyl acrylate, and 1.4 wt % of grafted maleic anhydride) were prepared using the procedure and conditions of Example 2.

35% (wt./wt.) of the resulting concentrate pellets and 65% (wt./wt.) of the linear low-density polyethylene resin (HIFOR® LF2020AA) were pellet blended and formed into a monolayer blown film using the procedure and conditions of Example 1.

This film was then subjected to testing for packing film properties. The results are reported in Table 1 below.

### Example 5—Comparative

Preparation of PE Film Containing Nylon and Compatibilizer (mal-EMAC®)

Pellets of a concentrate containing 55% (wt./wt.) of a linear low-density polyethylene (HIFOR® LF2020AA), 30% (wt./wt.) of a polyamide 6 without nanoparticles (Domo Chemical Domamide H40 F), 10% (wt./wt.) of an ethylene-vinyl alcohol copolymer (Kuraray EVAL F104B), and 5% (wt./wt.) of a maleated ethylene-methyl acrylate copolymer compatibilizer (melt index of 600 g/10 min., 24 wt % methyl acrylate, and 1.4 wt % of grafted maleic anhydride) were prepared using the procedure and conditions of Example 2.

35% (wt./wt.) of the resulting concentrate pellets and 65% (wt./wt.) of the linear low-density polyethylene resin (HIFOR® LF2020AA) were pellet blended and formed into a monolayer blown film using the procedure and conditions of Example 1.

This film was then subjected to testing for packing film properties. The results are reported in Table 1 below.

### Example 6—Inventive

### Preparation of PE Film Containing Nanocomposite but No Compatibilizer

Pellets of a concentrate containing 60% (wt./wt.) of a linear low-density polyethylene (HIFOR® LF2020AA), 30% (wt./wt.) of a polyamide 6 nanocomposite (Domo Chemical 1300 IF 102.3), and 10% (wt./wt.) of an ethylene-vinyl alcohol copolymer (Kuraray EVAL F104B) were prepared using the procedure and conditions of Example 2. This concentrate did not contain any maleated polyethylene homopolymer or copolymer.

35% (wt./wt.) of the resulting concentrate pellets and 65% (wt./wt.) of the linear low-density polyethylene resin (HIFOR® LF2020AA) were pellet blended and formed into a monolayer blown film using the procedure and conditions of Example 1.

This film was then subjected to testing for packing film properties. The results are reported in Table 1 below.

TABLE 1

| | Ex. 1 | Ex. 2 | Ex. 3 | Ex. 4 | Ex. 5 | Ex. 6 |
|---|---|---|---|---|---|---|
| Concentrate | | | | | | |
| Comp. | | | | | | |
| (wt %) | | | | | | |
| LLDPE | — | 55 | 55 | 55 | 55 | 60 |
| PA 6 | — | — | 30 | — | 30 | — |
| PA 6 | — | 30 | — | 30 | — | 30 |
| Nanocomposite | | | | | | |
| EVOH | — | 10 | 10 | 10 | 10 | 10 |
| mal-PE | — | 5 | 5 | — | — | — |
| mal-EMAC ® | — | — | — | 5 | 5 | — |
| Film Comp. | | | | | | |
| (wt. %) | | | | | | |
| Concentrate | — | 35 | 35 | 35 | 35 | 35 |
| LLDPE | 100 | 65 | 65 | 65 | 65 | 65 |
| Film | 1.4 | 1.5 | 1.4 | 1.5 | 1.6 | 1.4 |
| Thickness | | | | | | |
| (mil) | | | | | | |
| Optical | | | | | | |
| Properties | | | | | | |
| Gloss at 45° | 45.5 | 9.2 | 11.6 | 20 | 16.5 | 16.6 |
| Haze | 14.3 | 69.5 | 68.6 | 39.5 | 51.6 | 40.7 |
| (%) | | | | | | |
| Tensile | | | | | | |
| Strength | | | | | | |
| (psi) | | | | | | |
| At Break | | | | | | |
| TD | 6268 | 4142 | 2971 | 4201 | 2469 | 4626 |
| MD | 6245 | 5381 | 5054 | 5784 | 3944 | 6046 |
| At Yield | | | | | | |
| TD | 1586 | 1744 | 1371 | 1976 | 1334 | 2085 |
| MD | 1542 | 1886 | 1732 | 1996 | 1531 | 2098 |
| Tensile | | | | | | |
| Toughness | | | | | | |
| (ft-lbs/in³) | | | | | | |
| TD | 2295 | 1933 | 1300 | 1852 | 1058 | 2437 |
| MD | 2617 | 2374 | 2202 | 2574 | 1732 | 1994 |
| Elongation | | | | | | |
| (%) | | | | | | |
| TD | 1047 | 1011 | 856 | 941 | 790 | 953 |
| MD | 1026 | 943 | 886 | 958 | 839 | 859 |
| Secant | | | | | | |
| Modulus | | | | | | |
| (psi) | | | | | | |
| TD | 35100 | 34800 | 36200 | 48100 | 30600 | 44600 |
| MD | 30900 | 44900 | 34300 | 37300 | 34900 | 45400 |
| Puncture | | | | | | |
| Resistance | | | | | | |
| Force per mil | 8.44 | 5.93 | 5.56 | 6.21 | 2.7 | 6.11 |
| (lbs/mil) | | | | | | |
| Load at Break | 11.82 | 8.9 | 8.35 | 7.45 | 4.05 | 8.56 |
| (lbs) | | | | | | |
| Energy to | 4.54 | 2.1 | 1.85 | 1.82 | 1.75 | 2.31 |
| Break | | | | | | |
| (in-lbs) | | | | | | |
| Penetration | 4.24 | 2.7 | 2.45 | 2.5 | 2.4 | 3.15 |
| (inches) | | | | | | |
| Dart Impact | 152 | 161 | 116 | 136 | 85 | 122 |
| Strength (F50) | | | | | | |
| (g) | | | | | | |
| Elmendorf | | | | | | |
| Tear | | | | | | |
| (g) | | | | | | |
| TD | 887 | 941 | 722 | 1125 | 988 | 804 |
| MD | 531 | 509 | 340 | 473 | 341 | 409 |

As seen in Table 1, the film containing the nylon nanocomposite by itself (Example 6) performed as well as or better than the films containing a maleated polyethylene compatibilizer alone (Examples 3 and 5), particularly in optical properties, tensile strength, Secant modulus, puncture resistance, and dart impact strength. Additionally, the film containing the nylon nanocomposite by itself (Example 6) performed as well as or better than the films containing both a compatibilizer and the nylon nanocomposite (Examples 2 and 4), in terms of haze, tensile strength, and puncture resistance.

### Example 7—Comparative

### Preparation of PE Film Containing Nylon and EVOH But No Compatibilizer or Nanocomposite

60% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 without nanoparticles (Domo Chemical Domamide H40F), and 10% (wt./wt.) of an ethylene-vinyl alcohol copolymer (Kuraray EVAL F104B) were added in pellet form to a twin-screw extruder and melt blended to form a concentrate. The extrusion barrel temperature set point was 150° C. in zone 1, 200° C. in zone 2, 205° C. in zone 3, 245° C. in zone 4, 250° C. in zone 5 through zone 10, 240° C. in zone 11, 215° C. in zone 12, and 215° C. at the die. The screw speed was 275 RPM (revolutions per minute) with a 25 SCFH (Standard Cubic Foot per Hour) nitrogen purge rate and a total output of 12.5 pounds per hour. The melt blend concentrate was pelletized for further processing.

35% (wt./wt.) of the resulting concentrate pellets and 65% (wt./wt.) of the linear low-density polyethylene resin (HIFOR® LF2020AA) were added to the feed of a monolayer film blowing line as a pellet blend. The extrusion barrel temperature set point was 325° F. in zone 1, 450° F. in zone 2, 450° F. in zone 3, 420° F. in zone 4, 420° F. in zone 5, and 450° F. in all die zones. The screw speed was between 62 and 96 rpm, the melt pressure was between 1848 and 2399 psi.

Two attempts were made to blow a film with this formulation, but the bubble collapsed on the blown film line each time, and a film could not be pulled.

### Example 8—Repeated Control

### Preparation of PE Film

100% (wt./wt.) of a linear low-density polyethylene (Westlake Chemical HIFOR® LF2020AA having a melt index of 1.0 g/10 min. and density of 0.919 g/cm³) was added to the feed of a monolayer film blowing line. The extrusion barrel temperature set point was 325° F. in zone 1, 450° F. in zone 2, 450° F. in zone 3, 420° F. in zone 4, 420° F. in zone 5, 461° F. in the adapter, 461° F. in die zone 1, 461° F. in die zone 2, and 469° F. in die zone 3. The screw speed was between 66 and 105 rpm, the melt pressure was between 1,249 and 2,000 psi, the nip pressure was 45 psi, the air temperature was 48-49° F., the film speed was 110-150 fpm (feet per minute), the bubble height was 19′ (feet), the bubble width was 22.5″ (inches), and the film thickness was between 1.3 and 1.6 mil. The die gap was 100 mil, and the blow-up ratio was 2.5:1. The output of the process was 170 lbs/hr.

This film was then subjected to testing for packing film properties. The results are reported in Table 2 below.

### Example 9—Comparative

### Preparation of PE Film Containing Nylon but No Nanocomposite or Compatibilizer

70% (wt./wt.) of a linear low-density polyethylene (Westlake Chemical HIFOR® LF2020AA having a melt index of 1.0 g/10 min. and density of 0.919 g/cm³) and 30% (wt./wt.) of a polyamide 6 without nanoparticles (Domo Chemical Domamide H40 F) were added in pellet form to a 40-mm twin-screw extruder and melt blended to form a concentrate. The extrusion barrel temperature set point was 225° C. in zone 2, 235° C. in zone 3, 240° C. in zone 4, 245° C. in zones 5 through 12, and 248° C. at the die. The screw speed was between 275 and 325 RPM (revolutions per minute) with a 25 SCFH (Standard Cubic Foot per Hour) nitrogen purge rate and a total output between 55 and 60 pounds per hour. The melt blend concentrate was pelletized for further processing. This concentrate did not contain any maleated polyethylene homopolymer or copolymer.

35% (wt./wt.) of the resulting concentrate pellets and 65% (wt./wt.) of the linear low-density polyethylene resin (HIFOR® LF2020AA) were added to the feed of a monolayer film blowing line as a pellet blend to form a blown film. The film blowing line was operated at the same conditions as Example 8.

This film was then subjected to testing for packing film properties. The results are reported in Table 2 below.

### Example 10—Inventive

### Preparation of PE Film Containing Nanocomposite But No Compatibilizer

Pellets of a concentrate containing 70% (wt./wt.) of a linear low-density polyethylene (Westlake Chemical HIFOR® LF2020AA having a melt index of 1.0 g/10 min. and density of 0.919 g/cm³) and 30% (wt./wt.) of a polyamide 6 nanocomposite (Domo Chemical 1300 IF 102.3) were prepared using the procedure and conditions of Example 9. This concentrate did not contain any maleated polyethylene homopolymer or copolymer.

35% (wt./wt.) of the resulting concentrate pellets and 65% (wt./wt.) of the linear low-density polyethylene resin (HIFOR® LF2020AA) were added to the feed of a monolayer film blowing line as a pellet blend to form a blown film. The film blowing line was operated at the same conditions as Example 8.

This film was then subjected to testing for packing film properties. The results are reported in Table 2 below.

### Example 11—Comparative

### Preparation of PE Film Containing Nylon and EVOH but No Nanocomposite or Compatibilizer

Pellets of a concentrate containing 60% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 without nanoparticles (Domo Chemical Domamide H40 F), and 10% (wt./wt.) of an ethylene-vinyl alcohol copolymer (Kuraray EVAL F171B) were prepared using the procedure and conditions of Example 9. This concentrate did not contain any maleated polyethylene homopolymer or copolymer.

35% (wt./wt.) of the resulting concentrate pellets and 65% (wt./wt.) of the linear low-density polyethylene resin (HIFOR® LF2020AA) were added to the feed of a monolayer film blowing line as a pellet blend to form a blown film. The film blowing line was operated at the same conditions as Example 8.

This example used the same formulation as Example 7. It employed slightly different film forming conditions, however. While a consistent stable bubble for continuous operation was not able to be achieved, enough blown film was obtained for testing purposes.

This film was then subjected to testing for packing film properties. The results are reported in Table 2 below.

TABLE 2

| | Ex. 8 | Ex. 9 | Ex. 10 | Ex. 11 |
|---|---|---|---|---|
| Concentrate | | | | |
| Comp. | | | | |
| (wt %) | | | | |
| LLDPE | — | 70 | 70 | 60 |
| PA 6 | — | 30 | 0 | 30 |
| PA 6 | — | 0 | 30 | 0 |
| Nanocomposite | | | | |
| EVOH | — | 0 | 0 | 10 |
| mal-PE | — | — | — | — |
| mal-EMAC ® | — | — | — | — |
| Film Comp. | | | | |
| (wt. %) | | | | |
| Concentrate | — | 35 | 35 | 35 |
| LLDPE | 100 | 65 | 65 | 65 |
| Film | 1.3 | 1.4 | 1.4 | 1.6 |
| Thickness | | | | |
| (mil) | | | | |
| Optical | | | | |
| Properties | | | | |
| Gloss at 45° | 31.6 | 19 | 18.3 | 13.2 |
| Haze | 20.1 | 41.3 | 55.3 | 39.2 |
| (%) | | | | |
| Tensile | | | | |
| Strength | | | | |
| (psi) | | | | |
| At Break | | | | |
| TD | 5433 | 2517 | 3080 | 1813 |
| MD | 7343 | 4642 | 4991 | 3628 |
| At Yield | | | | |
| TD | 1530 | 1194 | 1360 | 980 |
| MD | 1536 | 1484 | 1721 | 1560 |
| Tensile | | | | |
| Toughness | | | | |
| (ft-lbs/in³) | | | | |
| TD | 2377 | 923 | 1176 | 652 |
| MD | 2792 | 1826 | 2313 | 1328 |
| Elongation | | | | |
| (%) | | | | |
| TD | 1102 | 740 | 835 | 619 |
| MD | 965 | 854 | 1041 | 646 |
| Secant | | | | |
| Modulus | | | | |
| (psi) | | | | |
| TD | 41700 | 38800 | 42800 | 35200 |
| MD | 38600 | 37400 | 47400 | 36100 |
| Puncture | | | | |
| Resistance | | | | |
| Force per mil | 6.56 | 4.57 | 4.09 | 1.86 |
| (lbs/mil) | | | | |
| Load at Break | 7.87 | 6.21 | 7.77 | 3.37 |
| (lbs) | | | | |
| Energy to | 2.66 | 6.21 | 7.77 | 3.37 |
| Break | | | | |
| (in-lbs) | | | | |
| Penetration | 3.08 | 2.26 | 2.67 | 2.39 |
| (inches) | | | | |
| Dart Impact | 145 | 112 | 155 | <50 |
| Strength (F50) | | | | |
| (g) | | | | |
| Elmendorf | | | | |
| Tear (g) | | | | |
| TD | 839 | 772 | 1069 | 890 |
| MD | 475 | 236 | 667 | 227 |

As seen in Table 2, in the compositions with no EVOH or compatibilizer (Examples 9 and 10), the film containing the nylon nanocomposite (Example 10) seemed to display slightly inferior optical properties but superior mechanical properties (e.g., tensile strength, tensile toughness, elongation, dart impact, and Elmendorf tear) than the corresponding film without the nylon nanocomposite (Example 9).

Moreover, as seen in Tables 1 and 2, while the formulations were blended and fabricated on separate occasions, in the presence of EVOH and in the absence of a compatibilizer, the film containing the nylon nanocomposite (Example 6) had comparable optical properties (e.g., gloss and haze) but superior mechanical properties (e.g., tensile strength, tensile toughness, elongation, Secant modulus, puncture resistance, dart impact, and Elmendorf tear) than the corresponding film without the nylon nanocomposite (Example 11).

### Example 12—Control

### Preparation of PE Cast Film

100% (wt./wt.) of a linear low-density polyethylene (Westlake Chemical HIFOR® LF2020AA having a melt index of 1.0 g/10 min. and density of 0.919 g/cm³) was added to the feed of a monolayer casting film line and formed into a monolayer cast film. The extrusion barrel temperature set point was 163° C. in zone 1, 187° C. in zone 2, 208° C. in zone 3, 220° C. in the adapter zone, and 245° C. in the die zone. The screw speed was 100 RPM. The melt pressure was between 2,668 and 3,305 psi. The melt temperature was between 235° C. and 243° C. The winder line speed was between 3 and 6 m/min, the nip tension was set at 7 Nm, and the winder tension was between 4 and 10 Nm. Film width was targeted at 5-6 inches using an 8-inch sheet die, and the film thickness was between 3.2 and 4.5 mil. The output of the process was between 3.8 and 5.2 lbs/hr. The chill-roll temperature was between 2° and 22° C.

### Example 13—Inventive

### Preparation of PE Cast Film Containing Nanocomposite But No Compatibilizer

70% (wt./wt.) of a linear low-density polyethylene (Westlake Chemical HIFOR® LF2020AA having a melt index of 1.0 g/10 min. and density of 0.919 g/cm³) and 30% (wt./wt.) of a polyamide 6 nanocomposite (Domo Chemical 1300 IF 102.3) were added in pellet form to a 40-mm twin-screw extruder and melt blended to form a concentrate. The extrusion barrel temperature set point was 225° C. in zone 2, 235° C. in zone 3, 240° C. in zone 4, 245° C. in zones 5 through 12, and 248° C. at the die. The screw speed was between 275 and 325 RPM (revolutions per minute) with a 25 SCFH (Standard Cubic Foot per Hour) nitrogen purge rate and a total output between 55 and 60 pounds per hour. The melt blend concentrate was pelletized for further processing. This concentrate did not contain any maleated polyethylene homopolymer or copolymer.

35% (wt./wt.) of the resulting concentrate pellets and 65% (wt./wt.) of the linear low-density polyethylene resin (HIFOR® LF2020AA) were added to the feed of a monolayer casting film line as a pellet blend to form a cast film. The casting film line was operated at the same conditions as Example 12.

This film was then subjected to testing for packing film properties. The results are reported in Table 3 below.

### Example 14—Inventive

### Preparation of PE Cast Film Containing Nanocomposite and EVOH But No Compatibilizer

Pellets of a concentrate containing 60% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 nanocomposite (Domo Chemical 1300 IF 102.3), and 10% (wt./wt.) of an ethylene-vinyl alcohol copolymer (Kuraray EVAL F171B) were prepared using the procedure and conditions of Example 13. This concentrate did not contain any maleated polyethylene homopolymer or copolymer.

35% (wt./wt.) of the resulting concentrate pellets and 65% (wt./wt.) of the linear low-density polyethylene resin (HIFOR® LF2020AA) were added to the feed of a monolayer casting film line as a pellet blend to form a cast film. The casting film line was operated at the same conditions as Example 12.

This film was then subjected to testing for packing film properties. The results are reported in Table 3 below.

### Example 15—Comparative

### Preparation of PE Cast Film Containing Nylon and EVOH But No Nanocomposite or Compatibilizer

Pellets of a concentrate containing 60% (wt./wt.) of a linear low-density polyethylene (Westlake Chemical HIFOR® LF2020AA having a melt index of 1.0 g/10 min. and density of 0.919 g/cm³), 30% (wt./wt.) of a polyamide 6 without nanoparticles (BASF B40), and 10% (wt./wt.) of an ethylene-vinyl alcohol copolymer (Kuraray EVAL F171B) were prepared using the procedure and conditions of Example 13. This concentrate did not contain any maleated polyethylene homopolymer or copolymer.

35% (wt./wt.) of the resulting concentrate pellets and 65% (wt./wt.) of the linear low-density polyethylene resin (HIFOR® LF2020AA) were added to the feed of a monolayer casting film line as a pellet blend to form a cast film. The casting film line was operated at the same conditions as Example 12.

This film was then subjected to testing for packing film properties. The results are reported in Table 3 below.

TABLE 3

| | Ex. 12 | Ex. 13 | Ex. 14 | Ex. 15 |
|---|---|---|---|---|
| Concentrate | | | | |
| Comp. | | | | |
| (wt %) | | | | |
| LLDPE | — | 70 | 60 | 60 |
| PA 6 | — | 0 | 0 | 30 |
| PA 6 | — | 30 | 30 | 0 |
| Nanocomposite | | | | |
| EVOH | — | 0 | 10 | 10 |
| mal-PE | — | — | — | — |
| mal-EMAC ® | — | — | — | — |
| Film Comp. | | | | |
| (wt. %) | | | | |
| Concentrate | — | 35 | 35 | 35 |
| LLDPE | 100 | 65 | 65 | 65 |
| Film | 3.9 | 4.0 | 4.5 | 3.2 |
| Thickness | | | | |
| (mil) | | | | |
| Optical | | | | |
| Properties | | | | |
| Clarity (%) | 99.3 | 80.3 | 52.1 | 46.9 |
| Gloss at 45° | 15.7 | 8.5 | 13.1 | 24.1 |
| Haze | 5.1 | 24.6 | 36.2 | 35.4 |
| (%) | | | | |
| Tensile | | | | |
| Strength | | | | |
| (psi) | | | | |
| At Break MD | 4616 | 5356 | 4823 | 4503 |
| At Yield MD | 1244 | 1712 | 1630 | 1526 |
| Tensile | | | | |
| Toughness | | | | |
| (ft-lbs/in³) | | | | |
| MD | 1990 | 1720 | 1457 | 1376 |
| Elongation | | | | |
| (%) | | | | |
| MD | 1008 | 781 | 720 | 669 |
| Secant | | | | |
| Modulus | | | | |
| (psi) | | | | |
| MD | 20400 | 29900 | 32600 | 23700 |
| Puncture | | | | |
| Resistance | | | | |
| Force per mil | 5.14 | 3.29 | 3.02 | 3.41 |
| (lbs/mil) | | | | |
| Load at Break | 14.81 | 9.8 | 10.69 | 12.28 |
| (lbs) | | | | |
| Energy to | 6.16 | 4.46 | 3.95 | 6.41 |
| Break | | | | |
| (in-lbs) | | | | |
| Penetration | 3.48 | 2.93 | 2.71 | 2.57 |
| (inches) | | | | |
| Elmendorf | | | | |
| Tear (g) | | | | |
| MD | 933 | 969 | 837 | 697 |

As seen in Table 3, in the compositions with EVOH present (Examples 14-15), in the absence of a compatibilizer, the cast film containing the nylon nanocomposite (Example 14) seemed to display comparable optical properties and slightly better mechanical properties (e.g., tensile strength, tensile toughness, elongation, and Elmendorf tear) than the corresponding film without the nylon nanocomposite (Example 15).

### Optical Microscopy Analysis

The films from Examples 2-6, 9-11, and 13-15 were also analyzed by optical microscopy.

The films were cut and placed between precleaned microslides made of Swiss glass with dimensions 25×75×1 mm. A Keyence VHX-2000E optical microscope with a VH-Z100R/W/T lens was employed for imaging. Software interface was VHX-2000 version 2.3.5.1. The permissible magnification for this lens was 100-1000×. The micrographs were captured at 200× magnification (unless otherwise noted) in reflectance mode.

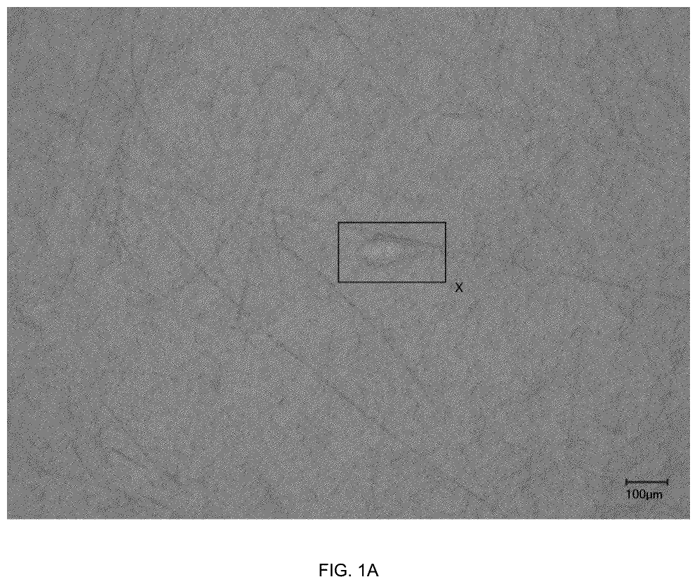

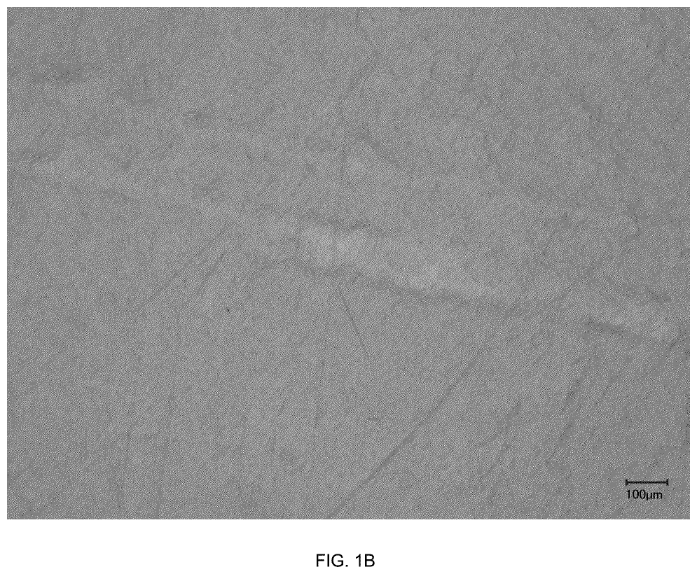

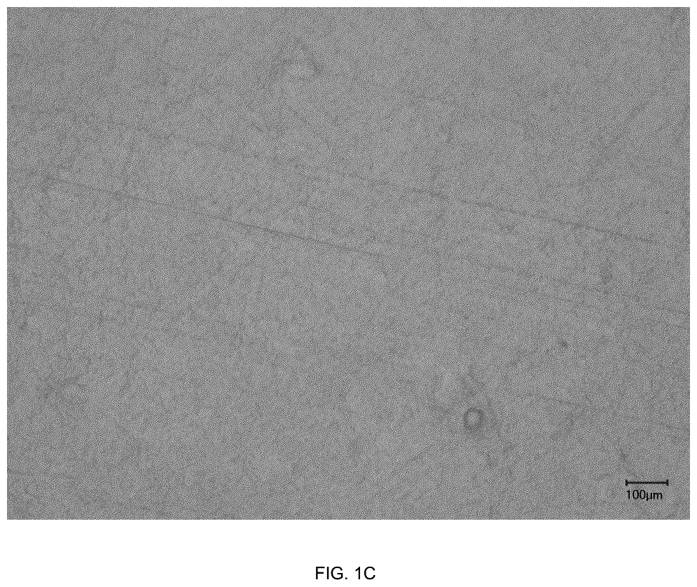

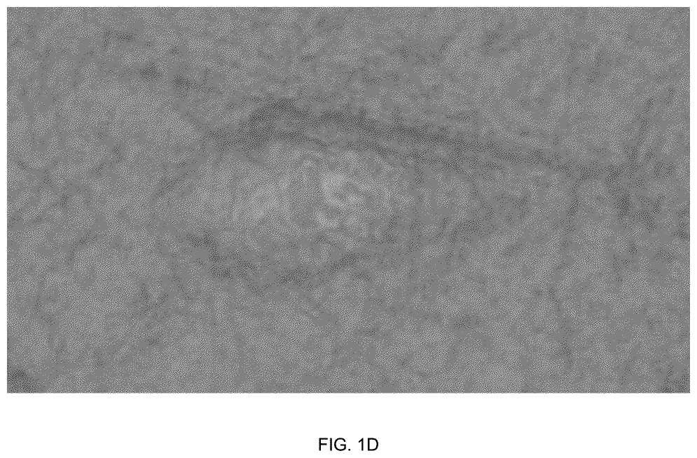

Three representative micrographs are shown for each composition in FIGS. 1-11, respectively.

For each composition, micrograph labeled (A) is representative of voids or unmelts, micrograph (B) is representative of gels, and micrograph labeled (C) is representative of immiscibility within the film.

Voids could be a physical opening in the film. Gels could be globs of likely dissimilar material thicker than surrounding film. Gels pose an obstruction to normal deformation by acting as stress concentration points. Immiscibility could be observed as surface roughness or inhomogeneity.

As seen in FIGS. 1A-1C (nanocomposite and RETAIN® compatibilizer (Example 2)), the microscopic images show a significant number of gels, immiscible phases, and some voids within the film.

FIG. 1D is an enlarged view of area X from FIG. 1A. It shows a large void in the film.

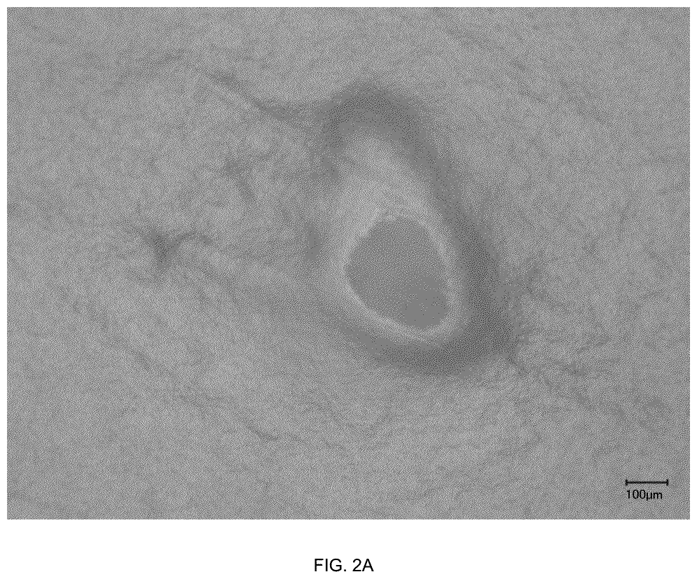

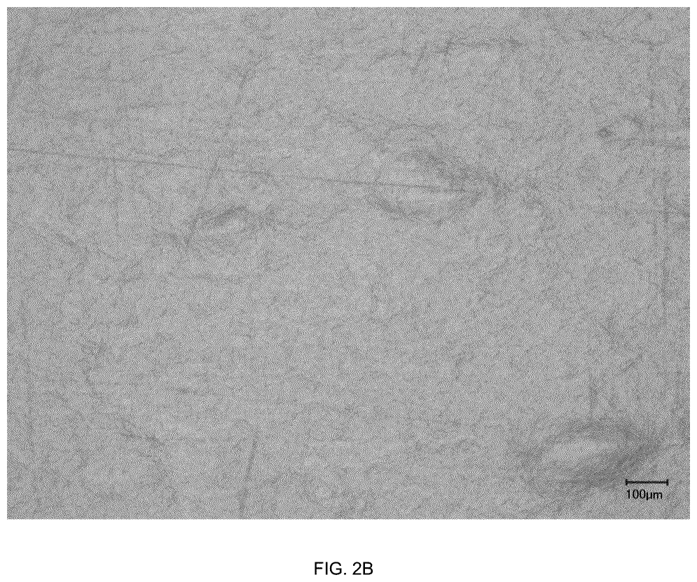

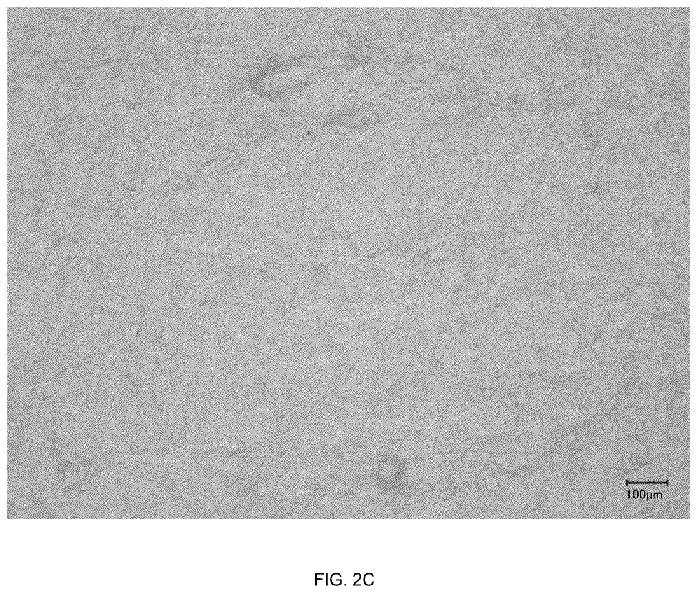

As seen in FIGS. 2A-2C (nylon and RETAIN® compatibilizer (Example 3)), the microscopic images show an excessive and detrimental number of unmelts (which were originally thought to be voids), gels, and immiscible phases within the film.

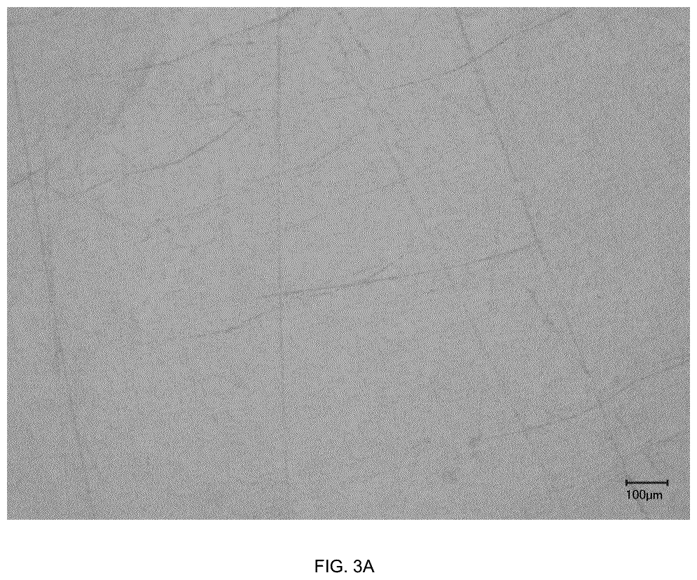

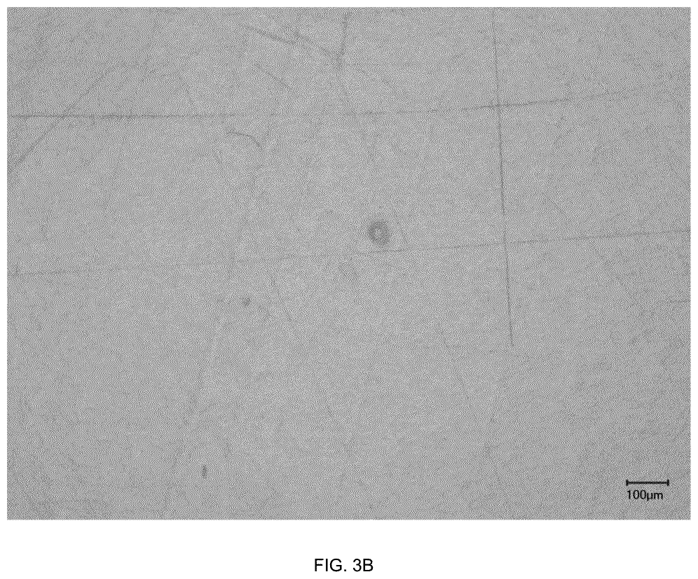

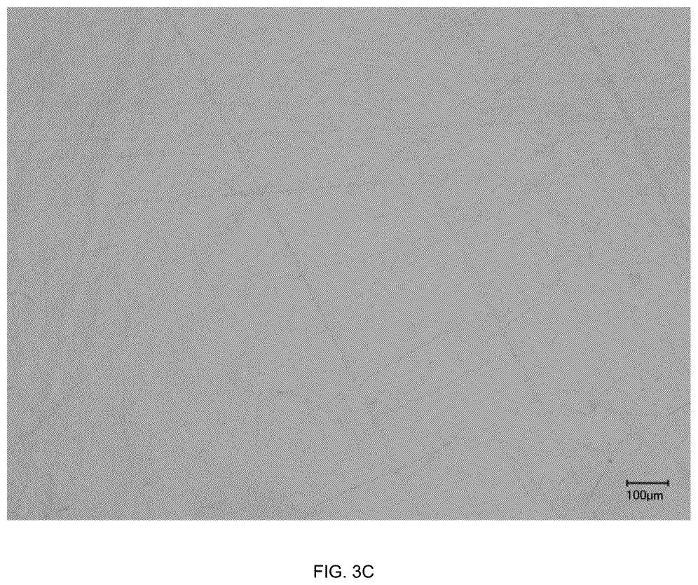

As seen in FIGS. 3A-3C (nanocomposite and mal-EMAC® compatibilizer (Example 4)), the microscopic images show no observable voids or immiscible phases, and an insignificant presence of only small gels.

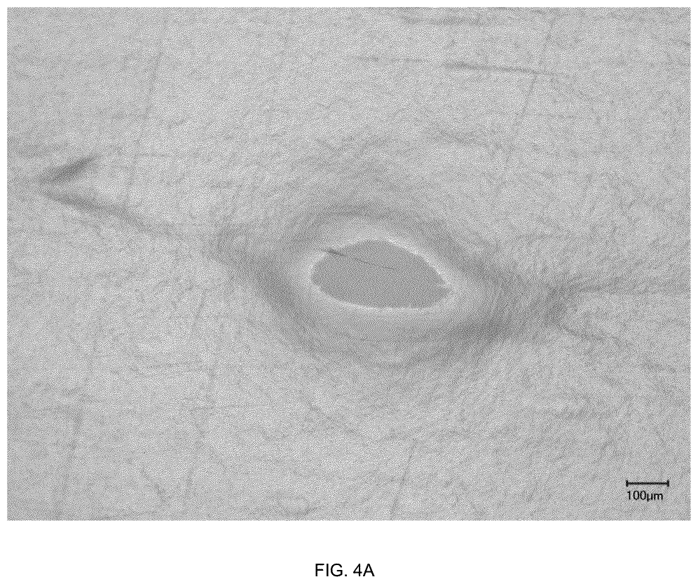

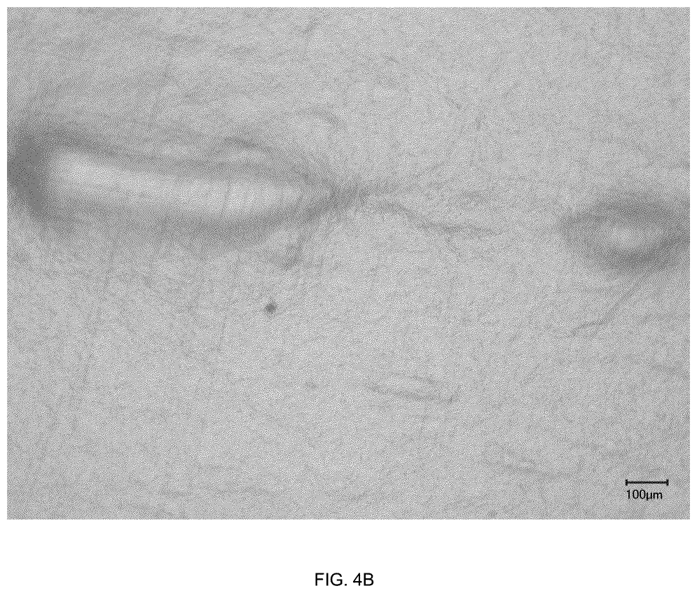

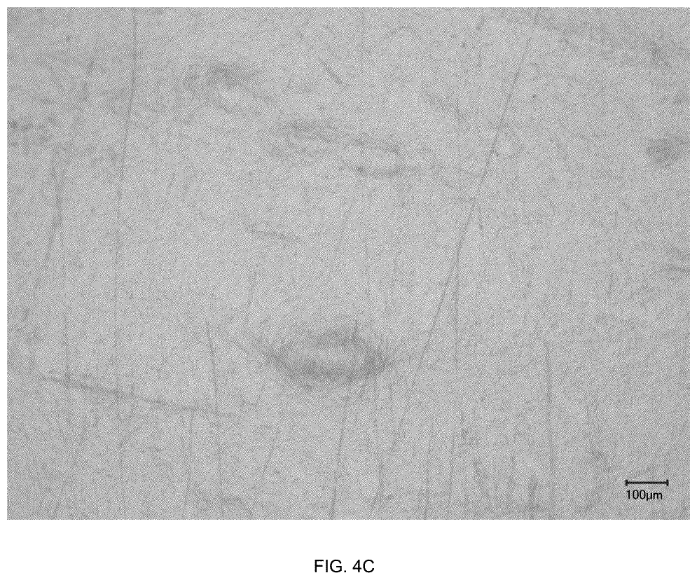

As seen in FIGS. 4A-4C (nylon and mal-EMAC® compatibilizer (Example 5)), the microscopic images show an excessive and detrimental extent of unmelts (which were originally thought to be voids) and gels. While not to a similar extent as the composition in Example 3, immiscibility was also observed.

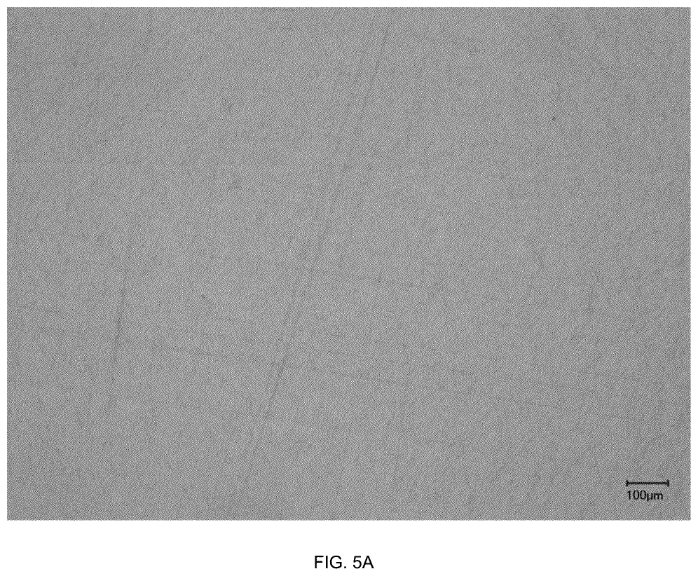

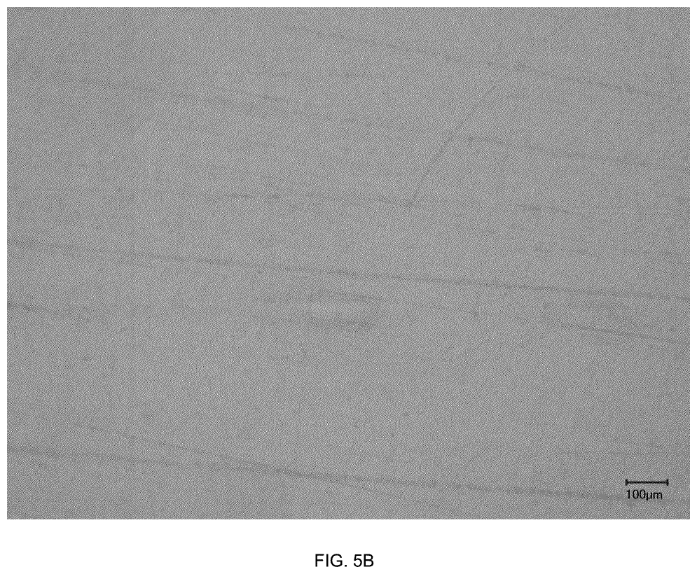

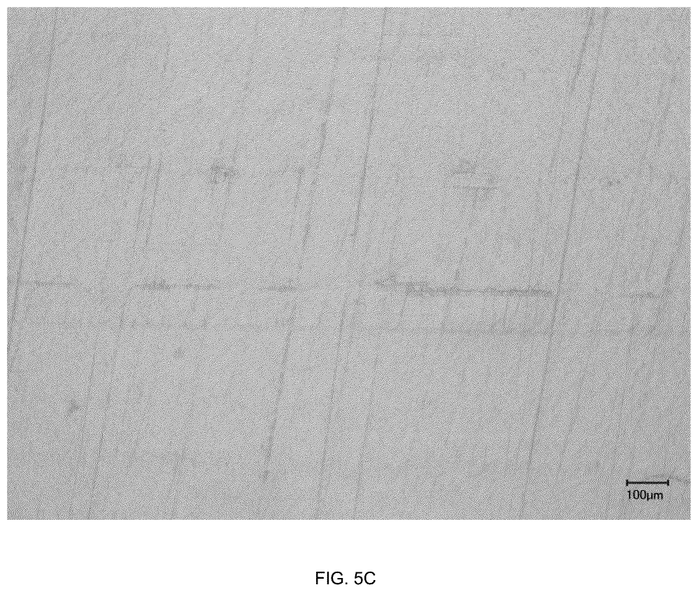

As seen in FIGS. 5A-5C (nanocomposite without compatibilizer (Example 6)), the microscopic images show the presence of some gels and immiscibility between the individual components of the blend, but surprisingly, no observable voids.

Among Examples 2-6, the films from Examples 4 and 6 had the best microscopic appearances. The film with only the nanocomposite (Example 6) appeared very similar to the film with the nanocomposite and the mal-EMAC® compatibilizer (Example 4).

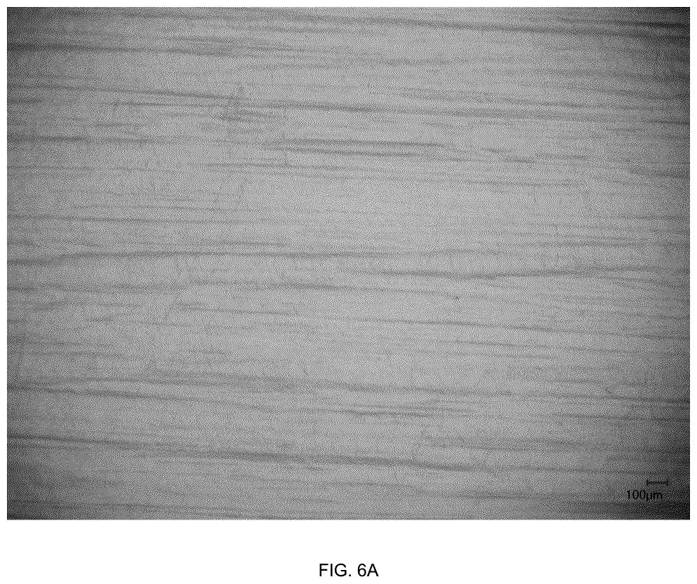

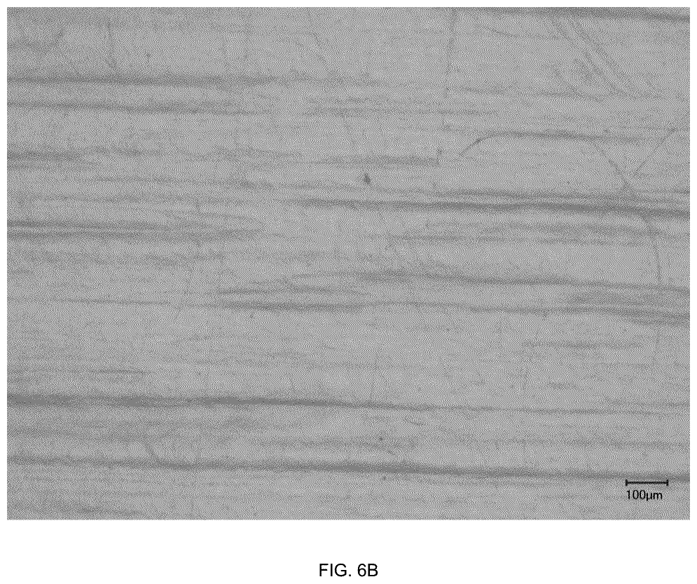

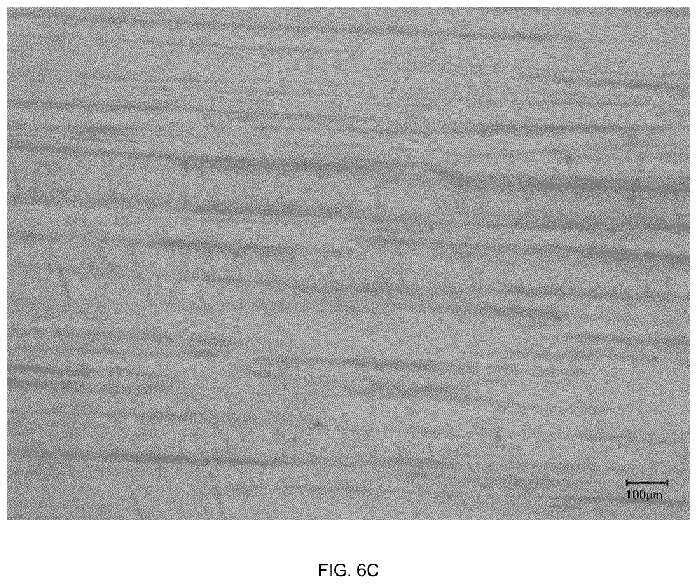

FIG. 6A was obtained at 100× magnification, and FIGS. 6B and 6C were obtained at 200× magnification. As seen in FIGS. 6A-6C (nylon without compatibilizer (Example 9)), while no voids were detected, the film was very poor in quality, showing huge striations in the flow direction. Miscibility was also very poor with clear surface roughness.

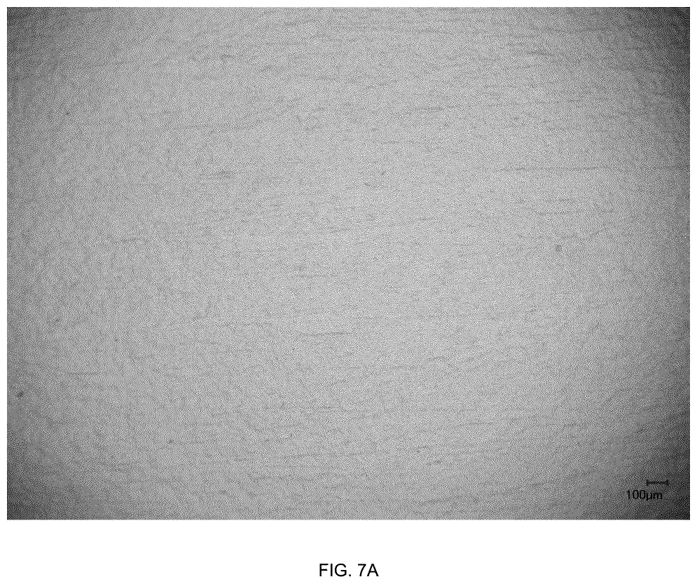

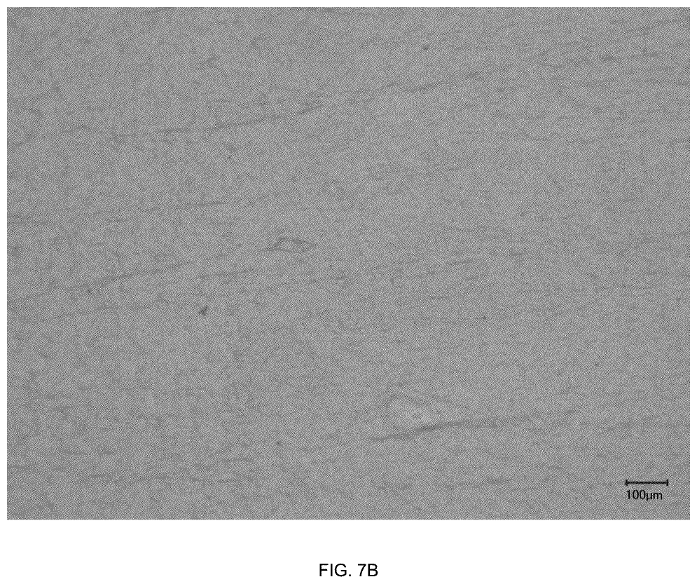

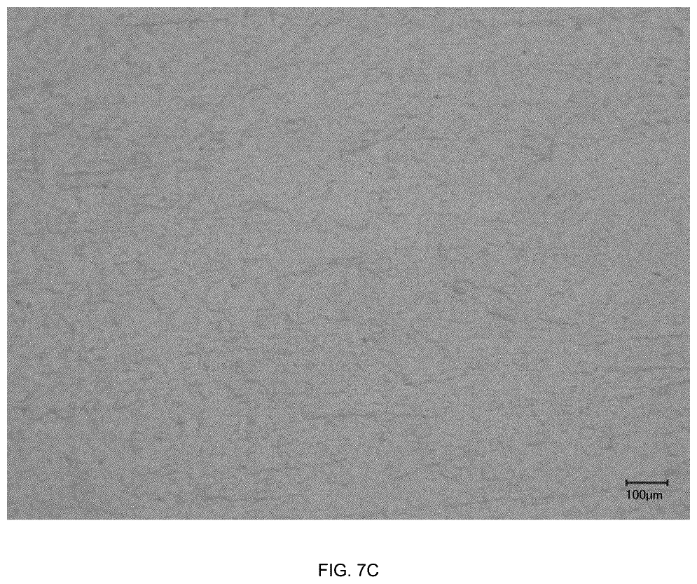

FIG. 7A was obtained at 100× magnification, while FIGS. 7B and 7C were obtained at 200× magnification. As seen in FIGS. 7A-7C (nanocomposite without compatibilizer (Example 10)), the film had no detectable voids, a small number of small gels, and good miscibility.

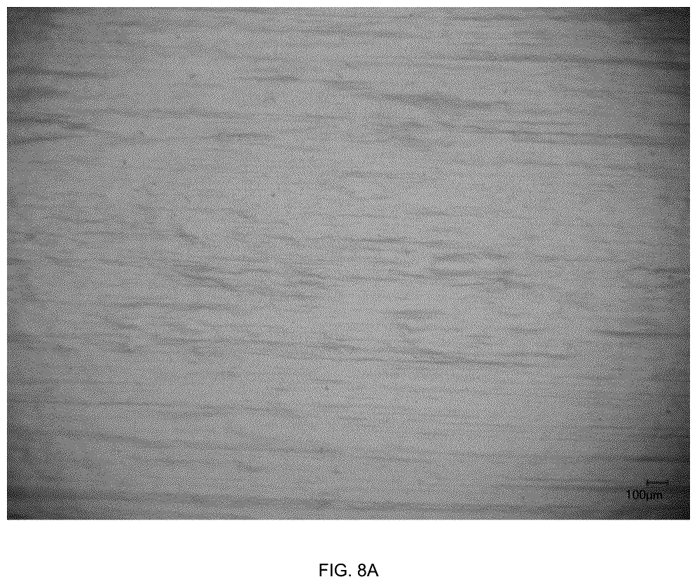

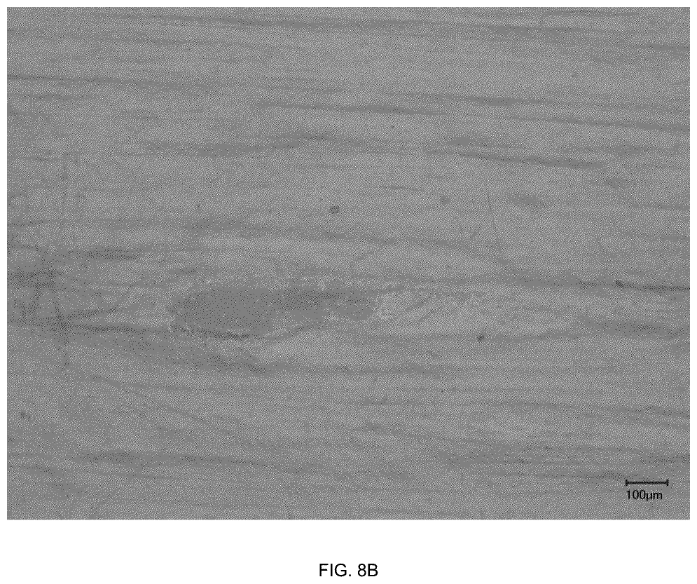

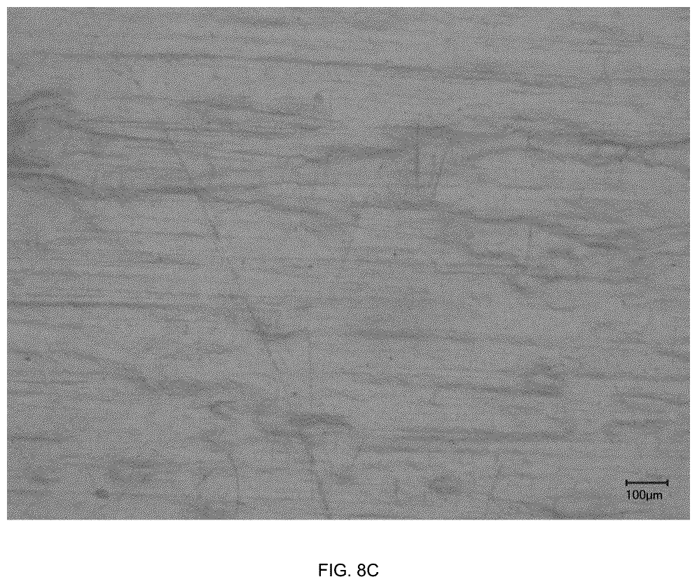

FIG. 8A was obtained at 100× magnification, while FIGS. 8B and 8C were obtained at 200× magnification. As seen in FIGS. 8A-8C (nylon and EVOH without compatibilizer (Example 11)), while no voids were detected, the film was very poor in quality, showing huge stretched out gels of the dispersion phase. Miscibility was also very poor with clear surface roughness. The material composition largely looks biphasic within the film.

Among Examples 9-11, the film with the nanocomposite but without the EVOH (Example 10) appeared the best, followed by the film without the nanocomposite or the EVOH (Example 9) and then the film with the EVOH but without the nanocomposite (Example 11).

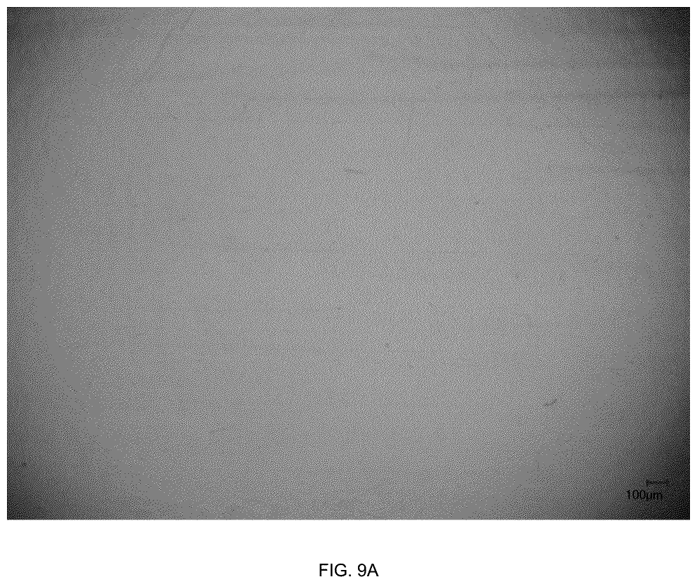

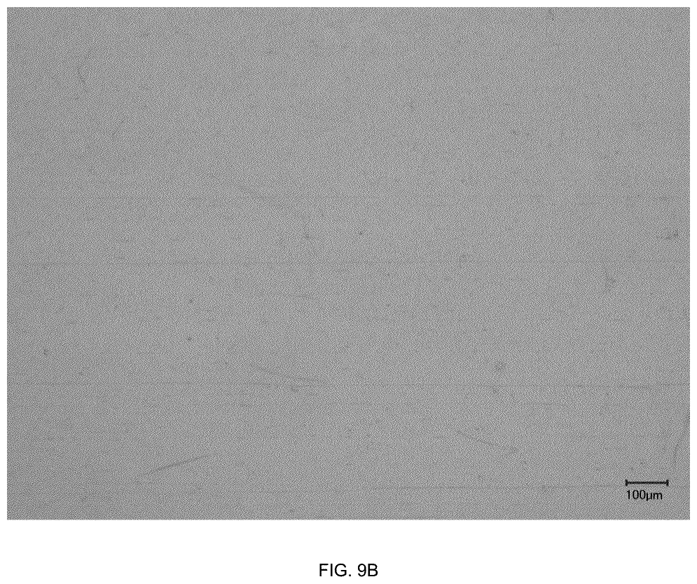

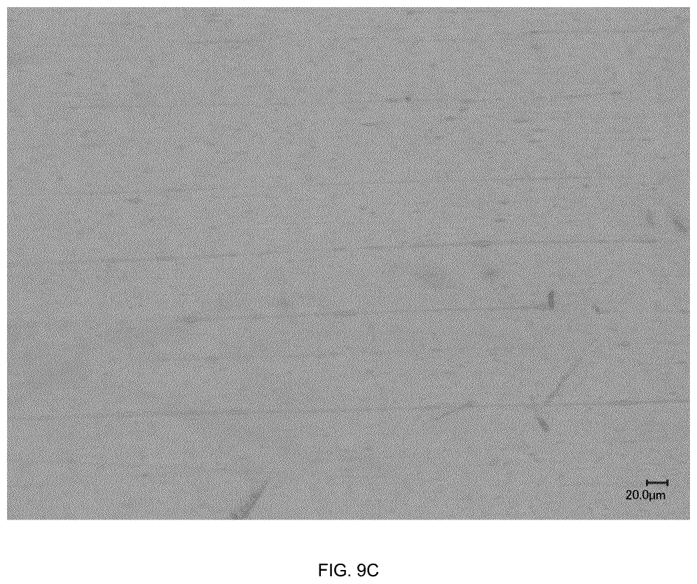

FIGS. 9A-9C were obtained at 100×, 200×, and 500× magnification, respectively. As seen in FIGS. 9A-9C (nanocomposite without compatibilizer (Example 13)), the film had no detectable voids, occasional small gels, and good miscibility. FIG. 9C at 500× magnification shows droplet breakup phenomena assisted by enhanced interfacial area (Ramic, A. J., et. al., Polymer 41 (2000) 6263-6270).

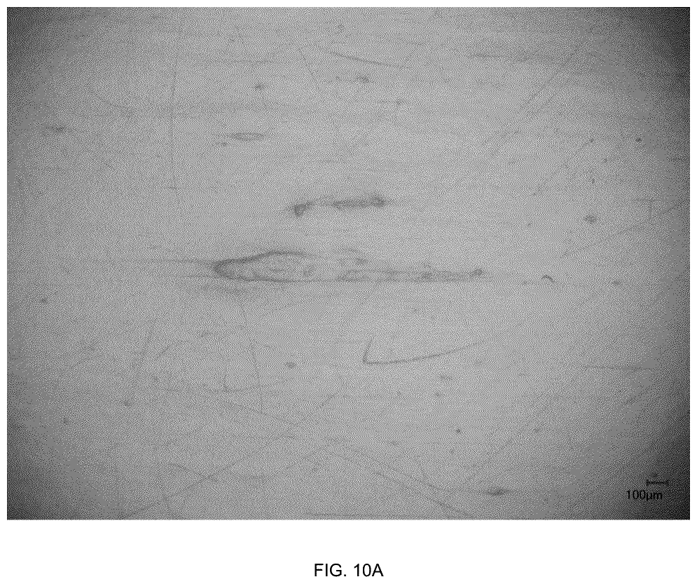

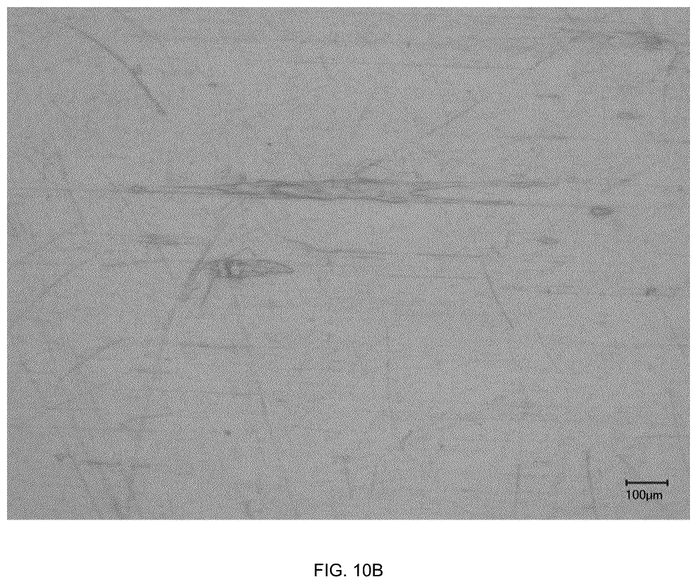

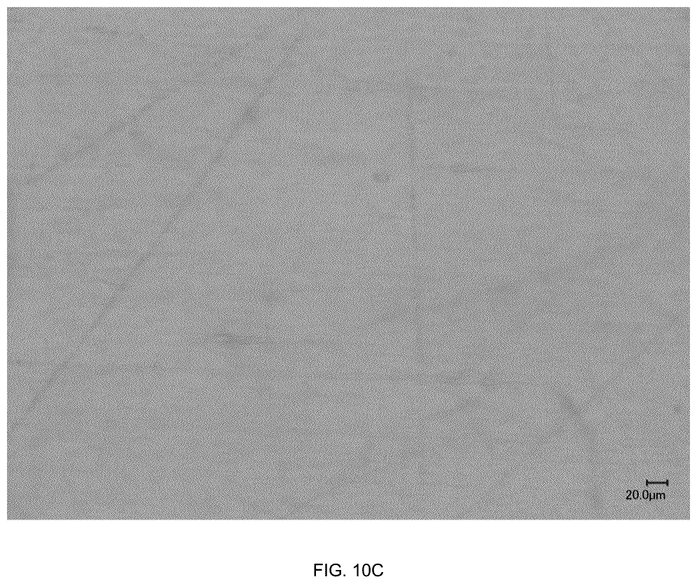

FIGS. 10A-10C were obtained at 100×, 200×, and 500× magnification, respectively. As seen in FIGS. 10A-10C (nanocomposite and EVOH without compatibilizer (Example 14)), the film had no detectable voids, but a considerable number of huge gels going through breakup in the flow direction and average miscibility. FIG. 10C at 500× magnification shows droplet breakup phenomena assisted by enhanced interfacial area, but to a lesser extent than the film from Example 13, owing to the presence of the EVOH.

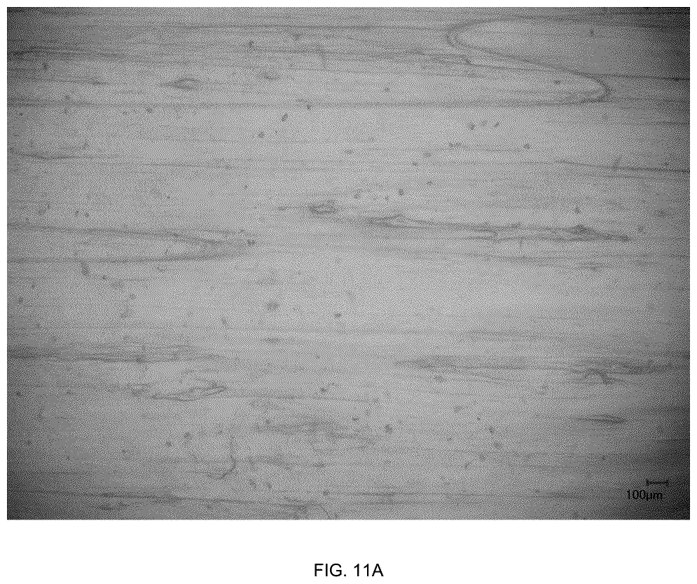

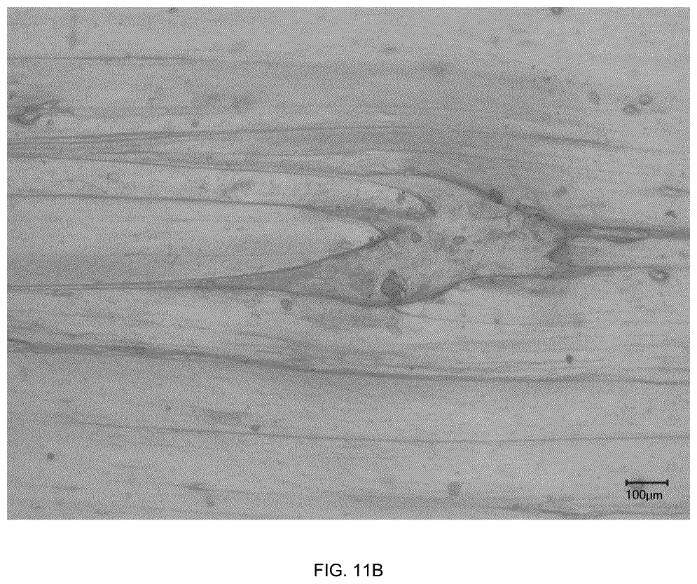

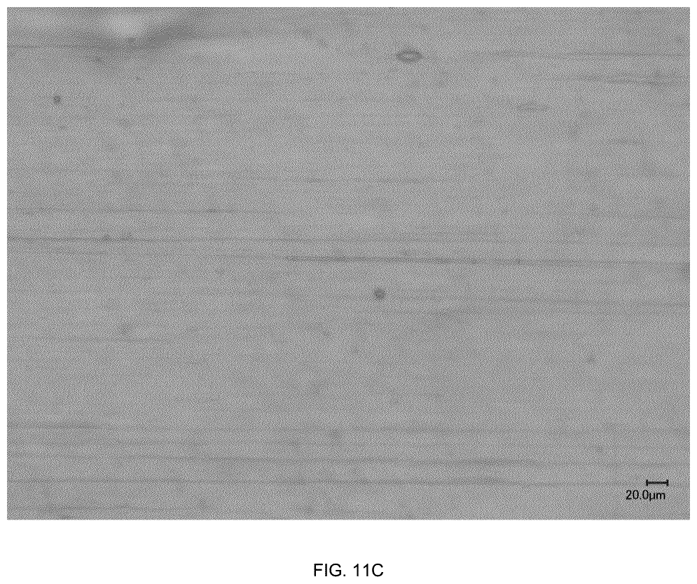

FIGS. 11A-11C were obtained at 100×, 200×, and 500× magnification, respectively. As seen in FIGS. 11A-11C (nylon and EVOH without compatibilizer (Example 15)), the film had no detectable voids, but a vast number of huge gels and poor miscibility. The material composition largely looks biphasic within the film.

Among Examples 13-15, the film with the nanocomposite but without the EVOH (Example 13) appeared the best, followed by the film with the nanocomposite and the EVOH (Example 14) and then the film with the EVOH but without the nanocomposite (Example 15).

In summary, without a compatibilizer, the nanocomposite delivers much better performance in both blown and cast films without EVOH than with it. Even in the presence of EVOH, the nanocomposite outperforms nylon alone.

The invention has been described in detail with particular reference to preferred embodiments thereof, but it will be understood that variations and modifications can be made within the spirit and scope of the invention.

We claim:

1. A composition comprising:
(a) an ungrafted ethylene-based polymer;
(b) a nanocomposite comprising a polyamide and montmorillonite; and
(c) optionally, an ethylene-vinyl alcohol (EVOH) copolymer,
wherein the composition is free of an added compatibilizer.

2. The composition of claim 1, wherein the ungrafted ethylene-based polymer comprises high-density polyethylene (HDPE), low-density polyethylene (LDPE), linear low-density polyethylene (LLDPE), very-low-density polyethylene (VLDPE), ultra-low-density polyethylene (ULDPE), or combinations thereof.

3. The composition of claim 1, wherein the ungrafted ethylene-based polymer has a melt index of 0.1 to 50 g/10 min.

4. The composition of claim 1, wherein the ungrafted ethylene-based polymer comprises LLDPE.

5. The composition of claim 1, wherein the polyamide comprises nylon 4.6, nylon 6, nylon 6.6, nylon 6.10, nylon 6.12, nylon 11, nylon 12, amorphous nylon, or combinations thereof.

6. The composition of claim 1, wherein the polyamide comprises nylon 6.

7. The composition of claim 1, wherein the compatibilizer comprises an epoxy-modified polystyrene copolymer, an ethylene-(meth)acrylate copolymer, an ethylene-alkyl (meth)acrylate copolymer, an ethylene-vinyl acetate copolymer, or combinations thereof.

8. The composition of claim 1, wherein the compatibilizer comprises an ethylene-methyl acrylate random or block copolymer, or an ethylene-butyl acrylate random or block copolymer.

9. The composition of claim 1, wherein the compatibilizer comprises an anhydride and/or carboxylic acid functionalized ethylene-based polymer.

10. The composition of claim 1, wherein the compatibilizer comprises a maleic anhydride grafted polyethylene, a maleic anhydride grafted ethylene-(meth)acrylate copolymer, a maleic anhydride grafted ethylene-alkyl (meth)acrylate copolymer, a maleic anhydride grafted ethylene-vinyl acetate copolymer, or combinations thereof.

11. The composition of claim 1, wherein the compatibilizer comprises a maleic anhydride grafted ethylene-methyl acrylate random or block copolymer, or a maleic anhydride grafted ethylene-butyl acrylate random or block copolymer.

12. The composition of claim 1, which comprises 70 to 99 wt % of the ungrafted ethylene-based polymer.

13. The composition of claim 1, which comprises 1 to 40 wt % of the nanocomposite.

14. The composition of claim 1, which comprises an EVOH copolymer.

15. The composition of claim 1, which excludes an EVOH copolymer.

16. The composition of claim 1, which further comprises a non-composited polyamide.

17. The composition of claim 1, wherein at least one of the ungrafted ethylene-based polymer, the non-composited polyamide, or the EVOH copolymer is sourced from post-industrial or post-consumer waste.

18. A film comprising at least one layer formed from the composition of claim 1.

19. A method of making a film, the method comprising extruding a melt of the composition of claim 1 through a die.
